(19) United States
(12) Patent Application Publication
(10) Pub. No.: US 2009/0258637 A1
(43) Pub. Date: Oct. 15, 2009

(54) Method for user identity tracking

(75) Inventors: Hanyu LIU, Beijing City (CN); Maodong XU, Beijing City (CN)

Correspondence Address: YH CHAN, 42 PIN OAKS DRIVE, PHOENIXVILLE, PA, 19460, US

(73) Assignee: BEIJING FOCUS WIRELESS MEDIA TECHNOLOGY CO., LTD., BEIJING CITY (CN)

(21) Appl. No.: 12/101,168

(22) Filed: Apr. 11, 2008

(51) Int. Cl. H04M 3/42

(52) U.S. Cl. 455/414.2

(57) ABSTRACT

The invention has disclosed a method for user identity tracking, and is suitable for wireless Internet. Precisely, mobile phone client end or WAP website sends user access request and parameters; user identity recognition server judges whether the user access request is for the first time; if so, it will distribute a unique user identifier, insert the user identifier in the returned information, and guide the mobile phone user to access the user identity recognition server based on the user identifier; read the recognition file on mobile phone, and complete the recognition of mobile phone user identity according to user identifier. With the technical proposal of the invention adopted, it is possible to realize the recognition on user identity through distributing the user identifier or through the corresponding relations between user identifier and users' mobile phone number.

### BACKGROUND OF THE INVENTION

The invention involves with the technical field of wireless Internet, and especially a method for user identity tracking.

Since the appearance of wireless Internet, personalized service has been the main characteristic service of wireless Internet, while one of the radical technical problems for realizing personalized service is user identification. Wireless Internet provides services for users through their mobile phone, while mobile phone is a highly-private telecom equipment, and the user identification on wireless Internet turns into the problem of recognition on users' mobile phone.

During the past long term, since Wap gateway sends users' mobile phone number to Wap website, users' mobile phone has naturally become the foundation for user identification by WAP website. However, since December 2005, China Mobile has adjusted Wap service strategy, and stopped providing users' mobile phone number to WAP website, so the user identification on WAP has become a hot-spot problem.

To solve the difficult problem of user identification, people have conducted many researches. The existing computer networks generally realize user identity recognition through sending a Cookie-based file to the storage unit of the accessing computer. However, under the existing wireless network, the main technical difficulty for realizing such Cookie-based user identity recognition rests with that, the background business system (with DotAd system as an example, it an application system for advertising issuance) is connected to cooperative Wap websites by means of Webservice, and users don't visit the website of DotAd actually. However, there will be the problem that Cookie could not realize cross-domain access if WAP website directly reads the Cookie written by DotAd system. The traditional method to solve such problems is just to excessively increase the burden of system performance, which is just to excessively increase the occupation of limited resources of users' mobile phone, and will greatly damage the service experience of users.

### BRIEF SUMMARY OF THE INVENTION

The invention aims at bringing forward a method for user identity tracking, and at realizing the recognition on user identity through distributing user identifier and storing the user identifier in users' mobile phone, or through gradually collecting the corresponding relations between user identifier and users' mobile phone number.

To realize this objective, the invention adopts the following technical proposal:

A method for user identity tracking, suitable for wireless Internet and includes the following steps:

A. Mobile phone client end or WAP website sends user access request and parameters to user identity recognition server;

B. The mentioned user identity recognition server judges whether the user access request is for the first time;

C. If it is the mobile phone user access request for the first time, the user identifier generation server will distribute a unique user identifier for mobile phone user, insert a user identity recognition label into the information returned to the mentioned mobile phone client end or WAP website, and guide the mobile phone user to access the user identity recognition server based on the mentioned user identity recognition label.

D. The mentioned user identity recognition server reads the recognition file on the mentioned mobile phone, and then completes the recognition of mobile phone user identity according to the user identifier generated from the mentioned user identifier generation server.

It also includes the following steps:

When judging whether the mentioned user access request is for the first time or not, the mentioned WAP website or mobile phone client end will read the user identifier, and inquire user identity recognition server according to Session ID; and also, the user behavior analysis server will send the desired information to mobile phone users according to their fancy.

The mentioned parameters sent by WAP website include WAP website ID, Session ID, WAP website user ID and advertising position ID.

The mentioned parameters sent by mobile phone client end include mobile phone client end ID, Session ID, cell client end user ID, and where, the mentioned mobile phone client end ID and the mentioned mobile phone client end user ID are the only correspondence.

The mentioned user identity recognition label is img label.

The mentioned recognition file on mobile phone is Cookie file or mobile phone client end storage file.

The mentioned judging whether the user access request is for the first time is determined through judging whether there is Session ID received in the user identity recognition form.

It also includes the following steps:

To receive the Wappush information and Wappush connection provided by WAP website;

To guide mobile phone user browser to Wappush browse server, and send out user identifier distribution request to the user identifier generation server;

Wappush browse server distributes a user identifier to each mobile phone user according to user identifier distribution request;

To receive the URL of WAP website and users' mobile phone number sent by means of URL data transfer;

To generate user identity file, and write in user identity file to the mentioned users' mobile phone according to the mentioned user identifier and users' mobile phone number.

The mentioned Wappush information is the content displayed on mobile phone screen when a mobile phone user receives Wappush; the mentioned Wappush connection is the address of related web page of a cooperative WAP website to which the mobile phone browser finally switches.

It also includes the following steps:

To establish the corresponding relation between the mentioned user identifier and users' mobile phone number;

The mentioned steps for guiding mobile phone user browser to Wappush browsing server further include the following steps:

Wappush issuance server transfers the mentioned Wappush information and Wappush connection to Wappush generation module;

The mentioned Wappush generation module generates Wappush information and Wappush connection, and then sends them back to Wappush issuance server;

Wappush issuance server sends corrected Wappush information and Wappush connection to users' mobile phone.

It also includes the following steps:

To analyze the URL of Wappush connection, obtain users' mobile phone number and Wappush connection of cooperative WAP websites;

To read the user identity Cookie of users' mobile phone or mobile phone client end storage file;

To judge whether the users' mobile phone has Cookie or mobile phone client end storage file which is corresponding to the mentioned user identifier;

If not, send user identifier distribution request packet to the user identifier generation server;

Read the user identifier response packet from the user identifier generation server, and thus obtain the newly distributed user identifier;

Write the complete user identity Cookie or mobile phone client end storage file including user identifier and users' mobile phone number to users' mobile phone;

In case the Cookie or mobile phone client end storage file in users' mobile phone only includes user identifier but not users' mobile phone number, send information updating request packet to user identifier generation server;

Write the complete Cookie or mobile phone client end storage file including user identifier and users' mobile phone number to users' mobile phone;

Users' mobile phone browser switches to the cooperative WAP website pointed at by PURL.

### BRIEF DESCRIPTION OF THE DRAWINGS

FIG. 1 is the flow chart of users' browsing for the first time in the detailed implementation method of this invention.

FIG. 2 is the flow chart of users' browsing for not the first time in the detailed implementation method of this invention.

FIG. 3 is the work flow chart of Wappush browse server in the detailed implementation method of this invention.

### DETAILED DESCRIPTION OF THE INVENTION

The following will further describe the technical proposal in this invention through detailed implementation methods.

The main idea of the invention is to make use of the technology that Session ID innuendo and WML graph label (img) of WAP website naturally guide users' browsing to solve the recognition on user identity.

The invention is described with DotAd system, and this system could be applied to cable network and wireless network. But what to be pointed out here that, this invention is not limited to the DotAd system, and other similar system could also realize the invention. The “similar system” mentioned here indicates the information issuance system providing background service, while such background service is not directly connected to mobile phone users, but provides information services for users indirectly through the websites browsed by users with similar Webservice method.

This invention hammers away at sending different advertising and other related information to different users based on Wap, so it is a must to break through the problem of user identification firstly. There are two important starting points for solving this technical problem:

1. The mobile phones of users, especially the most active Wap users, mostly support Cookie; to see from the future development, along with the updating of users' mobile phones, more and more users' mobile phones will provide support for Cookie. In the era of 3G, the barrier that Wap mobile phone doesn't support Cookie will become the history thoroughly. This is an important external condition for solving the problem of user identification.

On the other hand, the resource of users' mobile phone is extremely limited. In case all Wap websites write Cookie to users' mobile phone without limitation, the resource of users' mobile phone will be consumed up sooner or later, and thus affect the normal use of users.

2. Wappush is an important form for Wap website promotion at present, and absolutely most users know about Wap website and become website users through Wappush.

To start from these two key points, it is possible to form a set of relatively complete technical proposal which is based on Cookie and uses Wappush to solve the problem of user identification.

The following will firstly explain the terms used for the invention:

Wap: a wireless Internet service provided by mobile telecom operator for mobile users.

Wap website: the service provider providing wireless network information service for Wap users on the Wap platform provided by mobile operator. The information service provided by Wap website for Wap users is only available when users access the web pages of this web site actively. Such service is also called as Wap information browsing service, while Wap website could also be said as the information browsing service provider on Wap platform.

Wap gateway: the server set up by mobile telecom operator between mobile Internet and cable Internet. The request of mobile users for accessing Wap and the information provided by Wap website for users all need to be forwarded through this server.

URL: For accessing Wap website or the website of other information browsing server, users must know the overall address of such website, which is just called as URL. Besides marking the address of Wap website, URL could also transfer some certain data parameters to Wap website. For example, a typical URL could be described as: http://www.dotad.net?m=234. When users access this URL, at the same time when the overall address accessed is the website http://www.dotad.net, users transfer a parameter that the value m is 234. In case the URL used by users for accessing a website is not generated from users' own editing, but is provided by some other service provider, it has actually realized the data transfer between the service provider providing such URL and the accessed website. Such data transfer method just becomes URL data transfer method.

Wappush: Another form of Wap service. Different from Wap browsing service, service provider pushes information to users' mobile phone directly. Wappush comprises Wappush information and Wappush connection. After receiving Wappush, users may determine whether to access the website indicated by Wappush connection according to the contents of Wappush information. Common Wap websites don't have the conditions and ability for directly sending Wappush, and could only realize sending through special Wappush service provider. The sender of Wappush may transfer a small quantity of parameters to URL receiver by means of URL transfer.

DotAd system: This is an application system as an example shown by this invention. DotAd system takes cooperative Wap websites as the main service objects, and provides services in two aspects for them. Firstly, the system provides personalized advertising and other information services aiming at the fancy of different Wap users; secondly, the system provides Wappush channel for cooperative Wap websites, and helps such cooperative Wap websites to promote their services.

User identification: In normal conditions, information browsing service provider could not obtain the identity of accessing users directly, or it could be said that, in the model of information browsing service, “user identity is non-identifiable”. However, information browsing service provider could realize the “identification” on user identity through some technical means, namely know that the user A accessing this time and user B accessing previously are the same user. User identification is the foundation for extracting user accessing habit and hobbies, and for providing personalized services for them.

Cookie: It is one of the technical means for traditional information browsing service providers to realize user identification. Information browsing service provider could store some mark information at the user browser of the website being accessed in the form of small files at browser end, and users may read such information when they access this website next time. Such small files are called as Cookie. To ensure the security of information, there are three conditions for accessing Cookie. Firstly, the browser used by users must support Cookie; secondly, information browsing service provider could read or write Cookie only when they access the website directly; thirdly, Cookie is domain-related, that's to say, the Cookie written at some website could only be read by this website itself.

Simulated cross-domain access of Cookie: Cookie could not be accessed by crossing domains, but the demands on cross-domain access exist obviously. To realize the effect of cross-domain access of Cookie, technical personnel have developed some means for simulating cross-domain access. There are two kinds of such most common technical means. Firstly, in case website A needs to access the Cookie written by website B, it will make users' browser switch to website B firstly, later website B reads Cookie and then makes user browser switch back to website A, and transfers the contents of Cookie to website A by means of URL data transfer. The main defect of this method is that it extends the waiting time of users, increases the access quantity of website B, and brings performance pressure to website B. Secondly, all websites needing to share Cookie write a Cookie of the same to user browser. The main defect of this method is that it excessively occupies the resources of user browser end, and it is quite difficult to keep the synchronism of these Cookies.

Webservice: The browsing information provided by information browsing service website to users could also be completely or partially from other information browsing service websites. Technically speaking, such service method of inserting into web pages comprises foreground realization and background realization. Where, foreground realization indicates programming at user browser end, and guiding user browser to access different information browsing servers respectively; while background realization is also called as Webservice method, namely conduct programming at the server end of information browsing service provider, obtain browsing information from another information browsing server website, and transfer it to user browser. Foreground realization must obtain the support of user browser, while in Wap field, mobile phone browser doesn't support such foreground realization method, yet. To provide personalized advertising and other information services to mobile phone users being browsing cooperative Wap websites, DotAd system could only adopt the background Webservice method. Under such circumstances, user browser doesn't access the Wap website of DotAd actually.

Session: The continuous access by a same user to the same or different web pages of an information browsing service website is called session once. In actual systems, information browsing service website will distribute a SessionID which is effective within a short time for each session to realize session management. This SessionID is a 32-byte character string generated at random, and in case users don't access a web page for a long time in session, the session will go invalid.

img label: The browsing information returned by information browsing service website to user browser is described with the text label language stipulated in advance, namely HTML language at Web, and WML language at Wap. To describe multimedia web pages, these text label languages only provide one mark for embedded pictures, namely img label. Here, img label marks the size and position of pictures, as well as the URL in which a real picture is at the same time. After obtaining the browsing information of the whole web page, browser will access the URL corresponding by each img label in web page in turn, and obtain picture data.

Cooperative Wap website: It is an independent Wap website (non-Sp), and provides advertising position for DotAd system.

Mobile phone user: available to be simplified as user, indicates users browsing Wap website through mobile phone. Mobile phone user owns a private online mobile phone, and users accessing network with the same mobile phone will be regarded as one user, while the same user having and using different mobile phones for accessing network will be regarded as different users.

Advertising and other information sending client: client sending advertising or other information to mobile phone users through DotAd system.

Advertising or other information: information sent to mobile phone users by advertising and other information sending client with the expenditure on the account of the client.

Information issuance position: a position reserved at web pages of cooperative Wap websites for dynamic issuance of advertising or other information.

Did: The only 64 bit integer marking mobile phone users.

DotAd user database: Record the attribute information of mobile phone users with Did as index.

Wappush promotion: a service provided by DotAd system for cooperative Wap websites. Cooperative Wap websites may send Wappush through DotAd system platform to users' mobile phone, and thus promote their own website.

User browsing: When users browse a cooperative Wap website, this cooperative Wap website will automatically connect the DotAd information issuance system at the background. DotAd system uses the technology defined by the invention to realize user identification, and selectively provides advertising and other personalized information according to the records on users' fancy in user fancy information database.

User identity Cookie: The only unit installed at users' mobile phone for marking user identity, including user Did and a small quantity of other information which must be stored at users' mobile phone end.

The following will describe the system flow of the invention:

a. Description of System Flow

In DotAd user identification system, user has two ways to contact DotAd system. One is the way that users browse related web pages of DotAd cooperative Wap websites including DotAd advertising position; and the other is the way of Wappush. The invention is related to “user identification”, and mainly has such two ways, too.

Where, user browsing way mainly solves the problem of user identification, and is used as the firm foundation established for collecting and recording user access habit, and for providing personalized advertising and other information services. User browsing way is the main way for DotAd system to provide services for users, also the objective to be reached by this invention, namely the user identification technology, and the core procedure of the system as it were.

Wappush promotion procedure, as a service provided by DotAd system for cooperative Wap websites, mainly aims at assisting cooperative Wap websites to promote their services to mobile phone users, and is an auxiliary procedure (which will be introduced in detail later) of DotAd system. The invention has made some amendments to this procedure, added several important functional modules, made use of the instantaneous gap between that users click Wappush and that user browser truly switches to cooperative Wap website to write user identity Cookie to users' mobile phone, thus help the user identity recognition server of DotAd user browsing way to obtain the corresponding relation of user Did and users' mobile phone number, and make the user browsing way provider better services for users.

The following firstly describes the auxiliary Wappush promotion procedure.

b. Wappush Promotion Procedure

The basic function of Wappush promotion procedure is to provide promotion services for cooperative Wap website. To achieve this objective, Wappush system must push the Wappush information provided by Wap website to users' mobile phone. In case some user is interested in this information and clicks Wappush connection, user browser must make user browser switch to cooperative Wap website according to the stipulations on Wappush promotion service.

To realize the objective of user identification all the better, the invention has made pertinent amendments to this simple Wappush procedure.

Firstly, DotAd system doesn't send the Wappush information and Wappush connection provided by cooperative Wap website to users' mobile phone directly after receiving them, but makes some certain corrections firstly. Once some user is interested in Wappush information and clicks Wappush connection, user browser will firstly be led on to the browsing server of DotAd Wappush system, instead of Wap website. URL and users' mobile phone number of cooperative Wap website are all transferred to Wappush browsing server by means of URL data transfer.

Secondly, after user browser visits Wappush browsing server, the browsing server will complete the distribution of user Did and generate user identity Cookie at users' mobile phone end under the support of Did generation server.

Finally, user browser continuously switches to cooperative Wap website, and completes Wappush promotion service.

Technically, this process could be generalized as Wappush steering technology. DotAd system has just used this technology to capture the corresponding relation between user Did and users' mobile phone number.

c. Mobile Phone User Browsing Procedure

Mobile phone user browsing procedure is the core service procedure of DotAd system. When users browse related web pages of cooperative Wap website, cooperative Wap website will use the Webservice provided by DotAd at the background, so as to obtain personalized advertising or other information highly related to users' fancy as provided by DotAd system.

Due to the problem of cross-domain access of Cookie, DotAd system must guide users to actually connect to DotAd Wap website for realizing user identification. Such connection method is impossibly the traditional method of switching from cooperative Wap website to Wap website of DotAd system, since this modus operandi will bring tremendous technical risks to cooperative Wap websites. It indicates that once DotAd system has any problem, it is impossible to switch back to cooperative Wap website after switching to DotAd system, and all user accesses of cooperative Wap website will fail. The invention has adopted the method of img label potential guiding to guide user browser to access the Wap website of DotAd system, and thus solves this problem subtly.

On the other hand, the access of user browser to the Wap website of DotAd system will greatly increase the burden of DotAd system. This invention makes use of the SessionID distributed by the cooperative Wap website for session management to map and cache the results of user identification, ensures that each session of users only accesses the Wap website of DotAd system once, greatly enhances the efficiency of system and decreases the access pressure of system.

Concretely speaking, from the angle of DotAd system, the access of mobile phone users to Wap website comprises two processes, namely users' first browsing and secondary browsing at some Wap website. Here so-called “secondary” indicates that users browse the Wap web page including DotAd information position once again in the process of the same session.

DotAd system completes the recognition on user identity in the first browsing, and provides personalized advertising and other information services in users' secondary browsing.

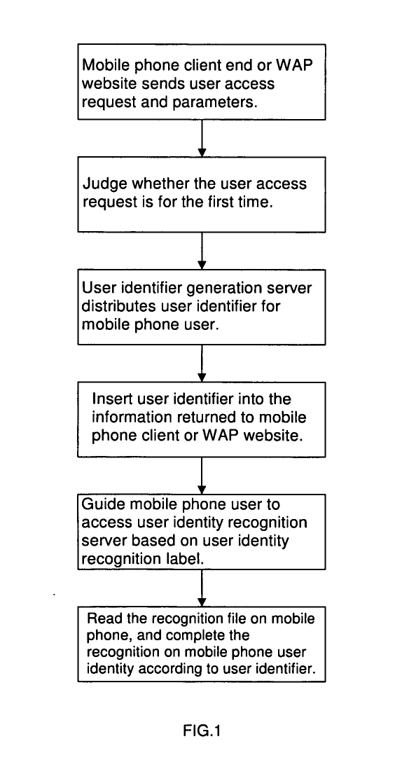

FIG. 1 is the flow chart of users' first browsing in the detailed implementation example of this invention. As shown in FIG. 1, in the first browsing of users, user browser has not accessed DotAd Wap website, and DotAd system could not realize the recognition on user identity, so DotAd system could only select advertising or other information at random, and send them to cooperative Wap websites. Personalized advertising and other information services could not be realized.

Here, what returned by DotAd system to Wap website includes not only the description information of conventional advertising or other information services, but also an additional img label not showing any image. The URL pointed at by this img label is not a picture, but the user identity recognition server of DotAd system. Therefore, in the process of accessing the URL of each picture in turn after obtaining and browsing web pages, user browser will naturally access the user identity recognition server of DotAd system naturally, and establish the internal mapping sheet between SessionID and Did of cooperative Wap website inside the server.

When users browse related web pages of cooperative Wap website once again, DotAd system could read the Did of related users from the internal mapping sheet according to the SessionID provided by Wap website, and thus realize the objective of user identification.

Technically, this process could be generalized as the internal mapping technology of SessionID and user Did, as well as the natural browser access technology of embedded img label. DotAd system has just realized the Cookie-based user identification through the successful application of these two technologies.

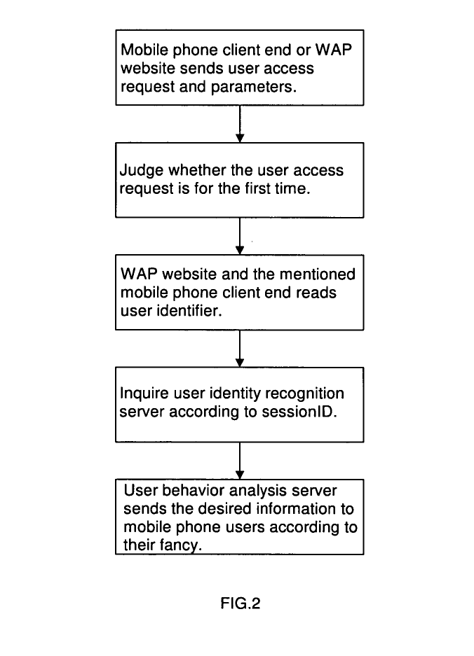

FIG. 2 is the flow chart of users' secondary browsing in the detailed implementation method of this invention. As shown in FIG. 2, the flow is basically the same as that shown in FIG. 1. Only that, after judging that it is not the first browsing of users, DotAd system will read user identification sheet, confirm user identity, and then send matching information according to the contents of user personal fancy information database as well as advertising and other information database.

The system in this invention comprises Wappush system S41, Did generation server S42, and DotAd personalized advertising and other information issuance system S43. Where, Wappush system and DotAd personalized advertising and other information issuance system are connected to Did generation server S43 respectively, and are used to realize Wappush promotion procedure and mobile phone user browsing procedure. Did generation server S43 provides Did management services for these two functional modules, so as to prevent the repetition of Did distributed to new users each time.

The following will introduce the details about the design and realization of each system module as abovementioned respectively.

We will introduce Did generation server S43 firstly.

The process that users click Wappush or browse web pages including DotAd information position at cooperative Wap website forms users' contact with DotAd system. When DotAd system contacts mobile phone users for the first time, it shall distribute a unique mark Did to users. Did generation server just takes charge of generating a new non-repeated Did for new users.

The main performance requirements on Did generation server are the fault tolerance ratio and efficiency. So-called fault tolerance indicates that the system won't crash in condition of hardware accidents such as power failure, etc., and could continue normal work after failure elimination. As also, efficiency indicates the ability to undertake over 1 million times of distribution task daily.

Did generation server takes charge of managing Did user marking system, and is at the core and fundamental position of the whole DotAd user identification system.

This Did generation server comprises Did generation service module and local Did database. Where, this Did generation service module is connected to local Did database. In addition, what directly connected to Did generation server also includes the Wappush browsing server of Wappush system, and the user identity recognition server of DotAd personalized advertising and other information issuance system. The two servers will be described in the following. Besides these two servers, to make it convenient for operation maintenance personnel to monitor the normal operation of the system, an independent monitoring server has been set up inside the system. This server has no direct relation with this invention, and won't be described in detail in the following description. In addition, what connected to local Did database also includes database synchronous module, and this database synchronous module is connected to the overall database. Monitoring server takes charge of monitoring the working state of the whole system. Database synchronous module takes charge of importing the contents of local Did database to the overall database periodically.

The following describes the main functions completed by Did generation server:
(1) To distribute a unique Did mark to new users;
(2) For users having been distributed Did but having not established the corresponding relations between Did and mobile phone number, establish the corresponding relation;
(3) To maintain and test interface.

Did Generation Service Module:

Did generation service module distributes continuous Did for new users according to the time sequence of access. Such distribution method could ensure that the distribution of user Did will never be repeated before all the Did space is distributed.

To calculate based on 360 million mobile phone users all over the country, 64 bit Did space could distribute 50 billion different Dids for each mobile phone user.

Local Did Database:

Did generation server records the Did distribution result to local Did database in the form of text log. The contents in this database will be imported by database synchronous module to DotAd overall database periodically. In DotAd system, Wappush sub-system has realized the Wappush promotion procedure of the system.

Through the switching of Wappush, DotAd user identification system could not only distribute Did to users, but also establish the corresponding relation between Did and users' mobile phone number. This has extremely important meanings for comprehensively using the plentiful user characteristic data established based on users' mobile phone and accumulated by Wap industry. The following describes this technology in detail.

This Wappush system comprises three parts, namely Wappush issuance server S61, Wappush browsing server S62, and Did generation server S63. Where, Did generation server is a basic and public server of DotAd system, and has been described above.

Wappush issuance server issues Wappush information to users according to the requirements of cooperative Wap website. Where the module directly related to the invention is Wappush generation module. It corrects the Wappush contents provided by cooperative Wap websites, guides users to access DotAd Wappush browsing server firstly when clicking the website, and transfers users' mobile phone number and the address of cooperative Wap website to Wappush browsing server by means of URL data transfer.

Wappush browsing server takes charge of updating the user identity Cookie on users' mobile phone under the support of Did generation server. This is the core module of Wappush system.

Cooperative Wap website sends Wappush request to Wappush issuance server, including Wappush information and Wappush connection.

Wappush issuance server transfers Wappush information and Wappush connection to Wappush generation module (the functions and effects of Wappush generation module will be described below);

Wappush generation module corrects Wappush information and Wappush connection, and then sends them back to Wappush issuance server.

Wappush issuance server sends the corrected Wappush of Wappush connection to users' mobile phone.

After reading Wappush information, if users are interested and click Wappush connection, users' mobile phone browser will switch to browsing server. Browsing server will obtain mobile phone number and the address of cooperative Wap website (by means of URL data transfer) through URL.

Browsing server sends out user Did distribution request to Did generation server (see the telecom protocol of Did generation server for details);

Did generation server distributes Did for users, records the corresponding relation of user Did and mobile phone number, and returns the distribution results to the browsing server (see the telecom protocol of Did generation server for details);

Browsing server writes user identity Cookie (including user Did and users' mobile phone number) to users' mobile phone, and user browser switches to Wap web pages of cooperative Wap websites.

Wappush systems adopts the above functional procedures to complete the realization of Wappush promotion procedure of DotAd system.

Where, Wappush information (PTEXT) indicates the contents seen on mobile phone screen by users when they receive Wappush; Wappush connection (PURL) indicates the address of related web page of cooperative Wap website, to which mobile phone browser will finally switch after users click Wappush; DotAd domain indicates the same Web domain in which all Dot servers are, and is defined as dotad.net; browsing server URL (LURL) indicates the overall address of browsing server, and is defined as a web page under DotAd domain, namely wap.dotad.net/wp.php.

In Wappush system, the functional modules related to user identification are Wappush generation module, browsing server module and Did generation server module.

The following describes Wappush issuance server. This Wappush issuance server includes receiving module, Wappush database, Wappush generation module and Wappush sending module. Where, the receiving module takes charge of receiving the Wappush request of cooperative Wap website, and writing the request to Wappush database; Wappush generation module reads corresponding data from Wappush database, corrects these data, and re-orientates user clicking to Wappush browsing server. Wappush sending module is connected to the Wap gateway provided by operator, and sends Wappush to mobile phone users through the telecom provided by operator.

The main function of Wappush generation module is to generate the Wappush contents actually sent by the system as well as Wappush connection according to the Wappush contents and Wappush connection provided by cooperative Wap website.

The module input parameter includes users' mobile phone number, Wappush contents and Wappush connection. The output result is just the Wappush code. The Wappush code generated will re-orientate user clicking to Wappush browsing server on the one hand, and will transfer the mobile phone number of users and the Wappush connection of cooperative Wap website to Wappush browsing server by means of URL data transfer.

The format of Wappush code is as shown below. Where, the information of the generated Wappush code will remain unchanged, and it is just the Wappush information provided by cooperative Wap website; the part of connection is changed into the following form:

“HTTP://”+LURL+“?mobile=”+mobile+“: url=”+PURL

Where,

1. The target address is defined as browsing server URL, and it's said that, once users click Wappush, user browser will switch to the browsing server defined by DotAd system;

2. Two parameters are transferred to browsing server by means of URL parameter transfer, namely users' mobile phone number and Wappush-connected URL. In this way, browsing server could distribute Did for users according to their cell phone number, and then switch to the web pages of cooperative Wap website very naturally.

After obtaining Wappush clicking access, this browsing server will generate Did according to users' mobile phone number, and write the Did to users' mobile phone in the form of Cookie.

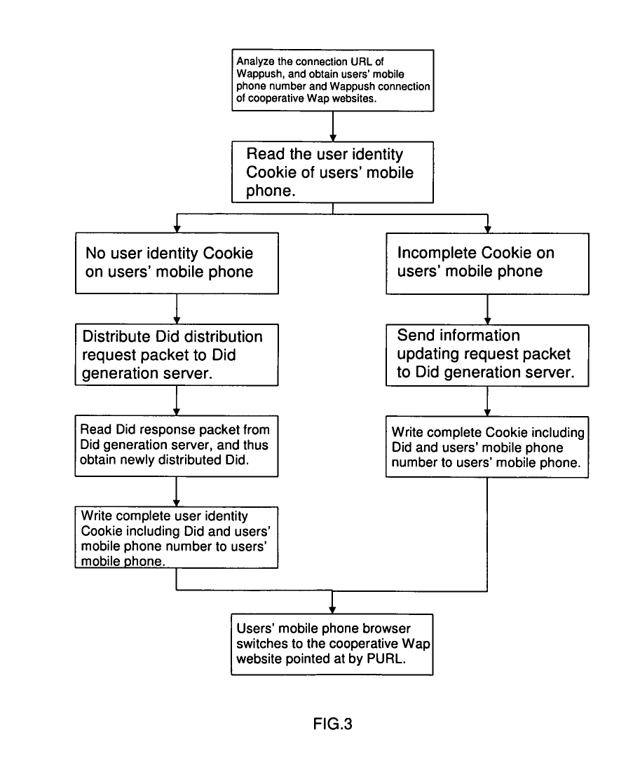

FIG. 3 is the working flow chart of Wappush browsing server in the detailed implementation method of this invention. As shown in FIG. 3, the working flow of Wappush browsing server includes:

1. Analyze Wappush-connected URL, and obtain users' mobile phone number and the Wappush connection (PURL) of cooperative Wap website (obtain parameters);

2. Read the user identity Cookie of users' mobile phone;

3. If there is no Cookie of Did on users' mobile phone, execute the processing procedures 3.1-3.3;

3.1 Send Did distribution request packet to Did generation server;

3.2 Read Did response packet from Did generation server, and thus obtain newly distributed Did;

3.3 Write complete user identity Cookie including Did and user cell phone number to users' mobile phone;

4. In case the Cookie on users' mobile phone is incomplete and only includes Did, instead of users' mobile phone number, execute the processing procedures 4.1-4.2;

4.1 Send information updating request to Did generation server;

4.2 Write complete Cookie including Did and users' mobile phone number to users' mobile phone;

5. Users' mobile phone browser switches to the cooperative Wap website pointed at by PURL.

Where, the configuration of user identity Cookie on users' mobile phone comprises the following several types:

1. No Cookie: It indicates that users contact DotAd system for the first time. Here, the system shall distribute Did for users, and generate user identity Cookie;

2. Incomplete user identity Cookie: Only include user Did but not users' mobile phone number. This indicates that the users have accessed DotAd in user browsing process, and user identity recognition server has distributed Did for users. Here, the system shall record the corresponding relation between user Did and users' mobile phone number, and update user identity Cookie to make it include user Did and mobile phone number.

3. Complete user identity Cookie: Namely include both mobile phone number and user Did. It indicates that users have every contacted DotAd system by Wappush promotion procedure, and Wappush browsing server has ever generated complete user identity Cookie for them. Here, user identification is completely normal, and the system needn't any operation for user identification.

Users browsing cooperative Wap website of DotAd is another way for users to contact DotAd system. It is the final objective of DotAd system to identify users at the cooperative Wap websites of DotAd browsed by users, and to provide personalized advertising and other information services for users according to identification results. Therefore, this part is the main body of the whole DotAd system.

To speak from the technical angle of user identification, the most primary technical difficulty rests with that DotAd system provides advertising information to cooperative Wap website by means of Webservice, and users don't actually access the web pages of DotAd system. Due to the restriction that Cookie could not be read or written by crossing domains, it is impossible to read or write Cookie at the end of cooperative Wap website. To solve this technical problem, the invention has brought forward two innovative technologies, namely cooperative Wap website SessionID and Did corresponding technology, and <img> label embedded natural access technology.

The part related to user identification of the DotAd and other information issuance system is composed of three main modules, namely Webservice module S102, user identity recognition server S104, and user identification sheet server S103.

To speak from functional flow, the technical key points of the system are as follows:

1. User identification sheet maintains the corresponding relation between SessionID and Did when users browse Wap website.

2. Webservice module inquires user identity according to the current SessionID and user identification sheet, and select the advertising and other information to be issued according to the fancy of users.

3. In case the current SessionID doesn't exist in user identification sheet, Webservice module will issue an advertising to users from the advertising database at random, and guide user browser to user identification module naturally.

4. When users access user identification module, which will read Cookie from users' mobile phone, and add the Cookie to user identification sheet.

The module at the cooperative Wap website end assists cooperative Wap websites to use Webservice, and establishes connection with DotAd system. Webservice module S102 sends advertising or other information matching users' fancy according to the results of user identification. User identification server S104 reads user identity Cookie, and identifies user identity. User identification sheet server S103 manages an EMS memory sheet and caches the results of user identification, and it is also a data interface between user identification server S104 and Webservice server S102.

When users browse a cooperative Wap website for the first time, the module at the cooperative Wap website end will send service request to Webservice server, and transfer parameters including Wap website ID, sessionID, Wap website userID and advertising position ID. Webservice server S102 selects one advertising or other information at random as a reply to the module at Wap network end, and meanwhile, inserts img label which will guide user cell phone browser to access user identity recognition server into the advertising information. Later, user browser accesses user identity recognition server, then the server reads the Cookie on users' mobile phone, and completes the recognition on user identity. Finally, user identification sheet server records the mapping relation between SessionID and user DID.

When users browse a cooperative Wap website once again, the module at the cooperative Wap website end will send service request to Webservice server. The parameters transferred are still Wap website ID, SessionID, Wap website user ID, and advertising position ID. Webservice inquires user identification sheet server by SessionID, reads user Did, and realizes personalized advertising and other information services on this foundation.

The following describes the detailed realization of each server respectively.

We will explain the following nouns one by one:

Session ID (sessionID): When a user browses a cooperative Wap website, Wap website will distribute a temporary 32-byte sessionID to him. In this way, in this browsing process of the user, Wap website will always maintain this sessionID to identity this session.

Wap website user ID (UID): In case a user has logged on a cooperative Wap website, then Wap website has already completed the identification of this user at this website. User ID is a user mark for cooperative Wap websites to mark the user.

Wap website ID (WapID): When a cooperative Wap website joins DotAd system, the 32 bit identifier distributed by the system will only mark Wap website inside DotAd system.

Advertising position ID: The identifier describing the advertising issuance position provided for DotAd system on related web pages of a cooperative Wap website.

User identity recognition server URL (RURL): User identity recognition server is a module at Wap server end. Its overall address is within DotAd, namely wap.dotad.net/ur.php.

Let's describe the user identification sheet server firstly.

User identification sheet provides the corresponding relation between the sessionID and user Did of cooperative Wap websites. The sheet adopts FIFO method for maintenance, and when the capacity of sheet is full, write new items to cover old contents in the sheet.

User identification sheet server provides the read-write interface of user identification sheet.

Each cooperative Wap website has a 4-byte ID inside DotAd system, which is called as WapID, and is used to identify each cooperative Wap website. When users browse Wap website, Wap website will distribute a temporary 32-byte SessionID to users for marking session. The same sessionID at the same Wap website could only be corresponding to one mobile phone user, and this is just the foundation for establishing user identification sheet.

User identification sheet is just the corresponding sheet of 4-byte website ID & 32-byte sessionID and 64 bit user Did.

To speak from structure, user identification sheet is divided into 256 independent sub-sheets, and each sub-sheet is corresponding to a sub-type of sessionID. In actual realization, the evidence for classifying sub-types is the arithmetical compliment of sessionID divided by 256. These 256 sub-sheets are not related mutually, but work completely independently.

Each sub-sheet comprises 4096 data items, and the data contained in each data item are as shown below:

| Sheet item | Type | Length (byte) | Description |
|---|---|---|---|
| WapID | ULONG | 4 | Only identifier of Wap website |
| SessionID | Character | 32 | Current sessionID |
| | string | | |
| Did | INT64 | 8 | Only mark of user in system |
| Final | ULONG | 4 | The final access time of this |
| access | | | item |
| time | | | |

Where, among the data items in the access (reading or writing) sheet of each time, the final access time will be updated to the current time (precise to second). In case of writing new data to the sheet after it is full, the new data will cover the items of the earliest final access time in the sheet.

The following describes the user identification sheet server, which provides the service of reading and writing user identification sheet for other servers of the system by means of remote procedure call (RPC). The detailed process is as shown below:

1) Reading User Identity

Input parameters: WapID and sessionID;

Output parameter: Did;

Algorithm:

1. Firstly, select a sub-sheet according to the value of sessionID%256;

2. Search the sub-sheet to see whether there are items matching both Wap website and sessionID;

3. If so, return to the Did in sheet item, and update the record of final access time;

4. If not, return to failure mark.

2) Writing User Identity

Input parameters: WapID, sessionID and Did;

Algorithm:

1. Firstly, select a sub-sheet according to the value of sessionID%256;

2. Search the sub-sheet to see whether there are items matching both Wap website and sessionID;

3. If so, return to the Did in sheet item, and update the record of final access time;

4. If not, write new data to a blank item or the item of the earliest final access time.

To speak from technical angle, user identification sheet server has adopted the core technologies of website SessionID and user Did mapping. This modus operandi has meanings in two aspects:

1. It is the foundation and precondition of img label guiding technology:

Compared with traditional switching technology, img label guiding technology has many advantages. However, img label delays the access, that's to say, it occurs after that the browsing information is completed and browsing web pages already returned to users' mobile phone browser. Therefore, in the process of generating browsing information this time, it is impossible to use any identification result of user identity recognition server guided by img label.

SessionID mapping technology could not solve the problem of using user identification results when the browsing information is generated this time. But with this technology, the identification result could be used when the browsing information is generated next time. To speak from some sense, SessionID mapping technology and img label guiding technology are two indispensable aspects of one technology, and without SessionID mapping, img label guiding will be meaningless.

2. It has reduced the access burden of user identification server:

Another important significance of SessionID mapping technology rests with that is realizes the user identification with session as unit. Compared with the user identification with browsing as unit, user identification is conducted only once in each session, instead of being conducted each time when users browse web pages. Undoubtedly, this will greatly reduce the access intensity of user identification server, thus reduce the cost of system, and increase the stability of system.

The following describes Webservice server, which is a main server for realizing DotAd and other information issuance procedures, and mainly completes the matching of users' fancy and the selection of advertising or other information.

The part directly related to the invention in Webservice server is the part guiding users' mobile phone browser to access user identification server, which is also a part significantly described in the specifications.

When users browse related web pages of a cooperative Wap website, Wap web site will use Webservice module to obtain advertising information matching with users' fancy. Webservice module reads user Did from user identification sheet according to the SessionID of users' browsing this time. In case of successful reading, the module will select advertising information according to Did and then return to Wap website; and in case of unsuccessful reading, the module will select a piece of advertising information at random and then return to Wap website, and meanwhile, it will guide user browser to access user identification server.

To realize the objective of naturally guiding user browser to access user identification module, Webservice module adopts <img> label embedding access technology for realization.

Webservice server is the core module of DotAd and other information issuance system. For user identification, on the one hand, Webservice module is the recipient of user identification result, and makes use of the result to provide personalized advertising and other information services. On the other hand, Webservice module guides users to user identification server, and is the pivot center of user identification.

The guiding algorithm of this Webservice server is mainly as shown below:

Input parameters: WapID and sessionID

Output parameter: corrected advertising information

Algorithm Procedure:

1. Webservice inlet:

2. Read user identification sheet;

3. If successful, select advertising according to Did, and return the advertising information to cooperative Wap websites;

4. If not, complete the following operations;

a) Select one piece of advertising at random;

b) Add one <img> label to advertising description information, which is 0 in length and width, and URL is defined as:

RURL+“?WapID=”+WapID+“:sessionID=”+sessionID

For example:

<img height=“0” width=“0” src=“wap.dotad.net/ur.php?WapID=135: sessionID=1234567”>

c) Send the corrected advertising information to the cooperative Wap websites.

Using img label to guide users' mobile phone browser to access user identification server is the core of Webservice server guiding algorithm. Compared with traditional browser switching method, using this method has the following advantages:

1. More excellent user experience:

Mobile phone browser shows users the intrinsic contents of web pages firstly, and then accesses the server connected to img label. Such guiding will not extend the waiting time of users, and thus improve users' experience.

2. Entire completion at background:

The size of pictures defined by the guiding img label is 0x0, so users could not feel the existence of this label directly. To see from the angle of users, this guiding process is completely realized at background.

Meanwhile, using img label guiding technology doesn't change the service protocol with cooperative Wap websites, or require any technical change of cooperative Wap websites for this purpose. To speak in a broad sense, this kind of guiding is also fully completed at background for cooperative Wap websites.

3. No additional risks to Wap website

Adopting switching method has tremendous technical risks for cooperative Wap websites. Once any failure occurs to DotAd system, and switching could not be completed smoothly, users will have no way to continuously access Wap websites. In this aspect, img label is much more excellent. Even if DotAd system crashes fully, users could still continuously browse Wap websites without any influence.

The following describes user identity recognition server, which finally realizes the recognition on user identity on the basis of the preparations of other modules in this invention.

Firstly, this server reads Cookie from users' mobile phone, and determines the identity of users. User identity recognition server is the module actually realizing user identification in the whole DotAd system, and is the final functional realizer of this invention.

User identity recognition server S104 firstly analyzes and accesses URL, and obtains the data of WapID and SessionID transferred by Webservice server by means of URL data transfer; and then accesses the user identity Cookie on users' mobile phone. If the access is unsuccessful, distribute a new Did for users through Did generation server, and generates user identity Cookie. Finally, user identity recognition server will transfer the result of user identification to user identification sheet server, and ends the user identification work.

The above describes the prior implementation examples of this invention. Obviously, relative to the existing technologies, the invention has the following advantages:

1.Each mobile phone user is marked with a unique corresponding Did;

When contacting a mobile phone user for the first time, DotAd system will distribute a unique Did for the user, and establish user database for the user inside the system. Along with the deepening of user service, related user information collected will be increasingly abundant, and the contents of user database will be gradually enriched.

2. User Did will be stored on users' mobile phone in the form of long-term effective Cookie;

3. The user identification process of DotAd system is transparent automatic work of system for cooperative Wap websites and mobile phone users. It needn't the active cooperation of cooperative Wap websites and mobile phone users, and will not bring any inconvenience for Wap website and users.

This invention has made use of sessionID and user Did internal mapping technology, and the natural browser access technology of embedded img label to successfully solve the technical problem of reading and writing the cookie to users' mobile phone at the background of DotAd; and has used Wappush switching technology to successfully solve the difficult correspondence of user Did and users' mobile phone number. The contents in these two aspects are the main technical key points of the invention, and have great innovation and practical value.

The abovementioned are just relatively good implementation methods of this invention, but the protective scope of this invention is not limited to this. Instead, within the scope of the technologies disclosed in this invention, any change or replacement easily occurring to any people familiar with the technology shall all be covered within the protective scope of this invention. Therefore, the protective scope of this invention shall give priority to the protective scope of claim of right.

What is claimed is:

1. This invention involves with a method for user identity tracking, it is suitable for wireless Internet, and is featured by including the following steps:
A. Mobile phone client end or WAP website sends user access request and parameters to user identity recognition server;
B. The mentioned user identity recognition server judges whether the user access request is for the first time;
C. If it is the mobile phone user access request for the first time, the user identifier generation server will distribute a unique user identifier for mobile phone user, insert a user identity recognition label into the information returned to the mentioned mobile phone client end or WAP website, and guide the mobile phone user to access the user identity recognition server based on the mentioned user identity recognition label;
D. The mentioned user identity recognition server reads the recognition file on the mentioned mobile phone, and then completes the recognition of mobile phone user identity according to the user identifier generated from the mentioned user identifier generation server.

2. According to a method for user identity tracking as mentioned in claim of Right 1, it is featured by also including the following steps:
When judging whether the mentioned user access request is for the first time or not, the mentioned WAP website or mobile phone client end will read the user identifier, and inquire user identity recognition server according to Session ID; and also, the user behavior analysis server will send the desired information to mobile phone users according to their fancy.

3. According to a method for user identity tracking as mentioned in claim of Right 1, it is featured by that the mentioned parameters sent by WAP website include WAP website ID, Session ID, WAP website user ID and advertising position ID.

4. According to a method for user identity tracking as mentioned in claim of Right 1, it is featured by that the mentioned parameters sent by mobile phone client end include mobile phone client end ID, Session ID, cell client end user ID, and where, the mentioned mobile phone client end ID and the mentioned mobile phone client end user ID are the only correspondence.

5. According to a method for user identity tracking as mentioned in claim of Right 1, it is featured by that the mentioned user identity recognition label is img label.

6. According to a method for user identity tracking as mentioned in claim of Right 1, it is featured by that the mentioned recognition file on mobile phone is Cookie file or mobile phone client end storage file.

7. According to a method for user identity tracking as mentioned in claim of Right 1, it is featured by that the mentioned judging whether the user access request is for the first time is determined through judging whether there is Session ID received in the user identity recognition form.

8. According to a method for user identity tracking as mentioned in claim of Right 1, it is featured by still including the following steps:
To receive the Wappush information and Wappush connection provided by WAP website;
To guide mobile phone user browser to Wappush browse server, and send out user identifier distribution request to the user identifier generation server;
Wappush browse server distributes a user identifier to each mobile phone user according to user identifier distribution request;
To receive the URL of WAP website and users' mobile phone number sent by means of URL data transfer;
To generate user identity file, and write in user identity file to the mentioned users' mobile phone according to the mentioned user identifier and users' mobile phone number.

9. According to a method for user identity tracking as mentioned in claim of Right 8, it is featured by that the mentioned Wappush information is the content displayed on mobile phone screen when a mobile phone user receives Wappush; the mentioned Wappush connection is the address of related web page of a cooperative WAP website to which the mobile phone browser finally switches.

10. According to a method for user identity tracking as mentioned in claim of Right 8, it is featured by still including the following steps:
To establish the corresponding relation between the mentioned user identifier and users' mobile phone number.

11. According to a method for user identity tracking as mentioned in claim of Right 8, it is featured by that the mentioned steps for guiding mobile phone user browser to Wappush browse server further include the following steps:
Wappush issuance server transfers the mentioned Wappush information and Wappush connection to Wappush generation module;
The mentioned Wappush generation module generates Wappush information and Wappush connection, and then sends them back to Wappush issuance server;
Wappush issuance server sends corrected Wappush information and Wappush connection to users' mobile phone.

12. According to a method for user identity tracking as mentioned in claim of Right 11, it is featured by still including the following steps:
To analyze the URL of Wappush connection, obtain users' mobile phone number and Wappush connection of cooperative WAP websites;
To read the user identity Cookie of users' mobile phone or mobile phone client end storage file;
To judge whether the users' mobile phone has Cookie or mobile phone client end storage file which is corresponding to the mentioned user identifier;
If not, send user identifier distribution request packet to the user identifier generation server;
Read the user identifier response packet from the user identifier generation server, and thus obtain the newly distributed user identifier;
Write the complete user identity Cookie or mobile phone client end storage file including user identifier and users' mobile phone number to users' mobile phone;
In case the Cookie or mobile phone client end storage file in users' mobile phone only includes user identifier but not users' mobile phone number, send information updating request packet to user identifier generation server;
Write the complete Cookie or mobile phone client end storage file including user identifier and users' mobile phone number to users' mobile phone;
Users' mobile phone browser switches to the cooperative WAP website pointed at by PURL.
